(19) United States
(12) Patent Application Publication
(10) Pub. No.: US 2016/0117852 A1
(43) Pub. Date: Apr. 28, 2016

(54) Enabling Consumers to Customize a Piece of Artwork

(71) Applicants: Rachel Brenchley, Kaysville, UT (US); Jason Hills, Orem, UT (US); Isaac Hess, Pleasant Grove, UT (US); Brandon Martin, Draper, UT (US); Sean Hess, Lindon, UT (US); Courtney Blair, Salt Lake City, UT (US); Audre Britton, Ogden, UT (US); Clairice Gifford, Salt Lake City, UT (US)

(72) Inventors: Rachel Brenchley, Kaysville, UT (US); Jason Hills, Orem, UT (US); Isaac Hess, Pleasant Grove, UT (US); Brandon Martin, Draper, UT (US); Sean Hess, Lindon, UT (US); Courtney Blair, Salt Lake City, UT (US); Audre Britton, Ogden, UT (US); Clairice Gifford, Salt Lake City, UT (US)

(21) Appl. No.: 14/809,976

(22) Filed: Jul. 27, 2015

Related U.S. Application Data
(60) Provisional application No. 62/029,207, filed on Jul. 25, 2014.

(51) Int. Cl. G06T 11/60; G06T 11/40; G06T 3/20; G06T 3/40; G06T 3/60

(52) U.S. Cl. CPC G06T 11/60; G06T 3/40; G06T 3/60; G06T 3/20; G06T 11/40

(57) ABSTRACT

A piece of artwork defined using a vector image format can be customized by the consumer. The consumer can select patterns to be applied to the shapes of the artwork as well as manipulate the appearance of the patterns once applied to the shapes. The manipulations can include translation, rotation, scaling, and inversion of the patterns. The manipulations that a consumer makes can be recorded so that they can be reapplied to a version of the artwork having a desired size. Multiple shapes can be grouped to facilitate applying and manipulating a pattern consistently across the grouped shapes. Relative values for manipulations can be generated to facilitate applying the manipulations consistently across versions of the artwork that have different aspect ratios.

### CROSS-REFERENCE TO RELATED APPLICATIONS

This application claims priority to U.S. Provisional Application No. 62/029,207 filed on Jul. 25, 2014.

### BACKGROUND

Scalable Vector Graphics (“SVG”) is an XML-based vector image format that can be used to define two-dimensional graphics. In SVG, complex shapes can be defined using paths which describe how to draw the shapes. Additionally, SVG provides some basic shapes as standard elements. Various attributes can be assigned to a shape including an outline color, a fill color, or a fill pattern. A shape may also be filled with a raster-based image such as a JPEG or PNG file.

### BRIEF SUMMARY

The present invention extends to methods, systems, and computer program products for enabling a consumer to customize a piece of artwork that is defined using SVG or another vector image format. The artwork can be displayed in a web browser or other computing interface along with various patterns that can be applied to shapes of the artwork. The consumer can select which pattern is applied to the shapes of the artwork.

The web browser or other computing interface may also include various controls that enable the consumer to manipulate a pattern once it has been applied to a shape of the artwork. These manipulations can include rotating, scaling, translating, and inverting the pattern within the shape among other manipulations. These manipulations can be stored as the user performs them to allow the manipulations to be reapplied to various versions of the artwork having different aspect ratios to create a customized piece of artwork. Relative values for the manipulations can be generated to allow the manipulations to be applied consistently in versions having different aspect ratios. Multiple shapes can be grouped to facilitate applying and manipulating a pattern consistently across the grouped shapes.

In one embodiment, the present invention is implemented as a method for enabling a consumer to customize artwork that is defined using a vector image format. A first version of a first piece of artwork is displayed on a computing device. The first piece of artwork includes one or more shapes that are defined using a vector image format. Each shape includes a pattern that is applied to the shape in accordance with the vector image format. User input is received that requests that a manipulation be applied to a first pattern that is applied to a first shape. The manipulation adjusts the appearance of the first pattern. In response to the user input, a manipulation value is stored in association with the first pattern. The manipulation value defines the manipulation that was applied to adjust the appearance of the first pattern.

In another embodiment, the present invention is implemented as a method for enabling a consumer to customize artwork that is defined using a vector image format. A first version of a first piece of artwork is displayed on a computing device. The first piece of artwork includes one or more shapes that are defined using a vector image format. Each shape includes a pattern that is applied to the shape in accordance with the vector image format. User input is received that requests that a first pattern be applied to a first shape. The definition of the first shape is updated such that the first pattern is applied to the first shape. It is determined that the first shape is grouped with one or more other shapes. The definition of each of the one or more other shapes is updated such that the first pattern is applied to the one or more other shapes.

In another embodiment, the present invention is implemented as one or more computer storage media storing computer executable instructions which when executed by one or more processors implement a method for enabling a consumer to customize artwork that is defined using a vector image format. A first piece of artwork is displayed on a computing device. The first piece of artwork is generated from a first Scalable Vector Graphics (SVG) file that defines a plurality of shapes for a first aspect ratio. User input is received that requests that a manipulation be applied to a first shape. The manipulation comprises one of a translation, a rotation, a scaling, or an inversion of a first pattern that is applied to the first shape. A manipulation value is stored that defines the manipulation. The manipulation value is defined with respect to the aspect ratio of the first SVG file. A second SVG file is selected that defines the plurality of shapes for a second aspect ratio. The first pattern is applied to the first shape in the second SVG file. The manipulation value is modified based on the second aspect ratio. The modified manipulation value is applied to the first shape in the second SVG file such that the first pattern is manipulated in the second SVG file in accordance with the manipulation that was made to the first pattern in the first SVG file.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer environment in which the present invention can be implemented;

FIG. 2A illustrates an example of an SVG file that includes three shapes;

FIG. 2B illustrates an editor toolbar that provides various options for manipulating a pattern that is applied to a shape;

FIG. 2C illustrates various manipulations that have been applied to the shapes;

FIGS. 3A-3D illustrate an example of an artwork editor that provides the ability to customize a piece of artwork by changing and manipulating the patterns that are applied to shapes in the artwork; and

FIG. 4 illustrates a flowchart of various steps that can be performed to implement embodiments of the invention.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

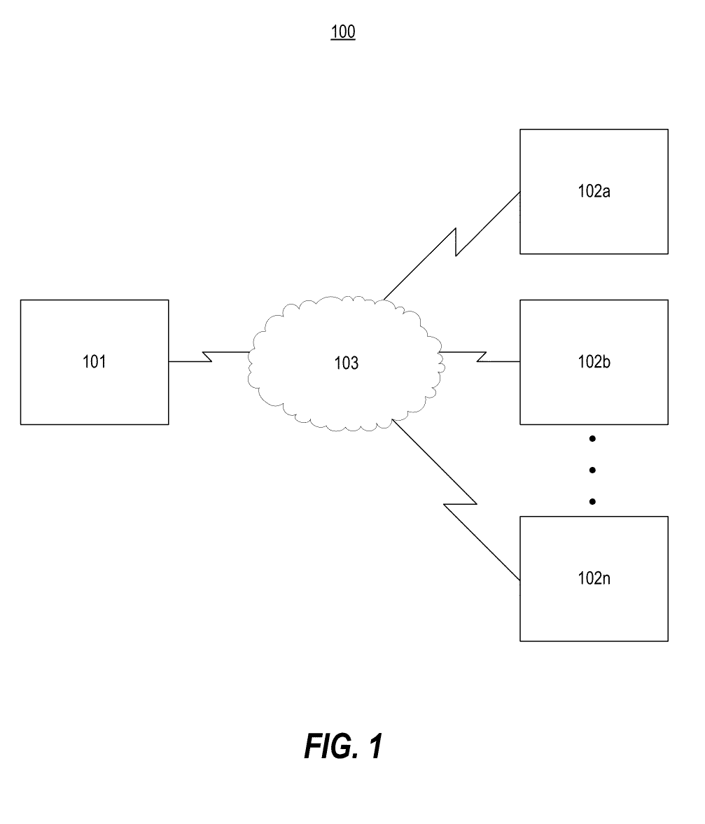

FIG. 1 illustrates an example computer environment 100 in which the present invention can be implemented. Computer environment 100 includes a server system 101, consumer computing devices 102a-102n, and a network 103 interconnecting server system 101 with consumer computing devices 102a-102n. Server system 101 can represent any number and configuration of server systems, devices, and/or components. For example, server system 101 can be a single server computing device or a cloud of server components. Similarly, consumer computing devices 102a-102n can represent the many different types of devices that can communicate with server system 101 via network 103. For example, consumer computing devices 102a-102n may represent desktop computers, laptop computers, tablets, smart phones, etc. Network 103 can typically be the internet although other network connections, such as local connections, could also be employed.

In a typical implementation, server system 101 can provide a website that consumer computing devices 102a-102n may access to display the artwork (e.g. in a browser). In other implementations, server system 101 can communicate with a dedicated application executing on consumer computing devices 102a-102n (e.g. a mobile application) to allow the dedicated application to display the artwork. The following discussion of the invention will describe a browser-based implementation of the invention. However, the invention should not be limited to any particular implementation or to any particular location where the functionality is performed.

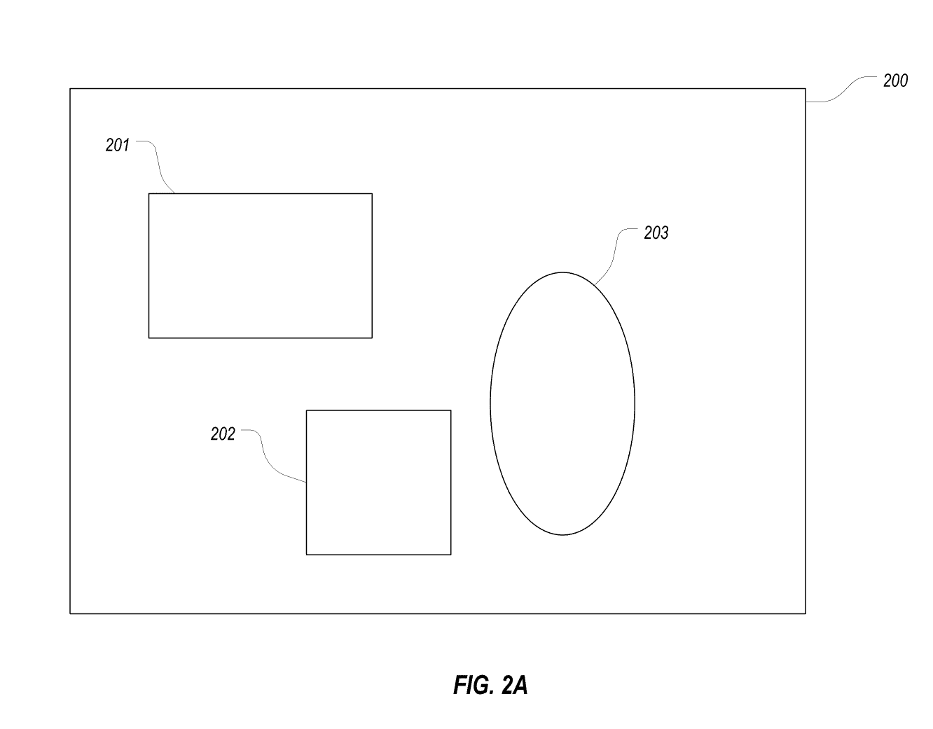

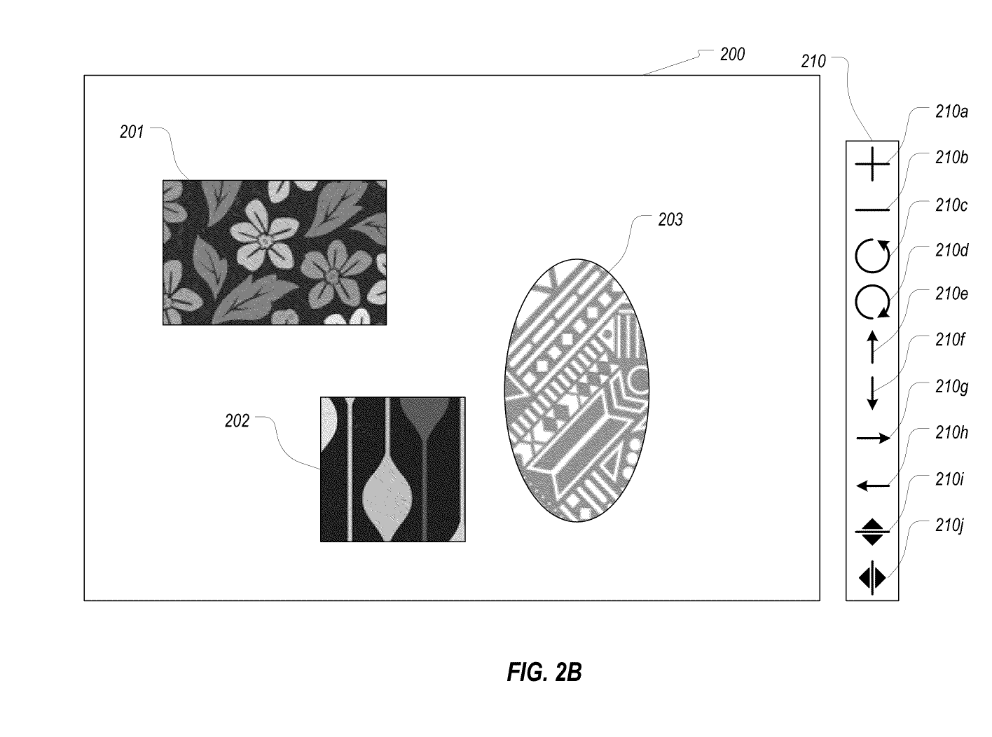

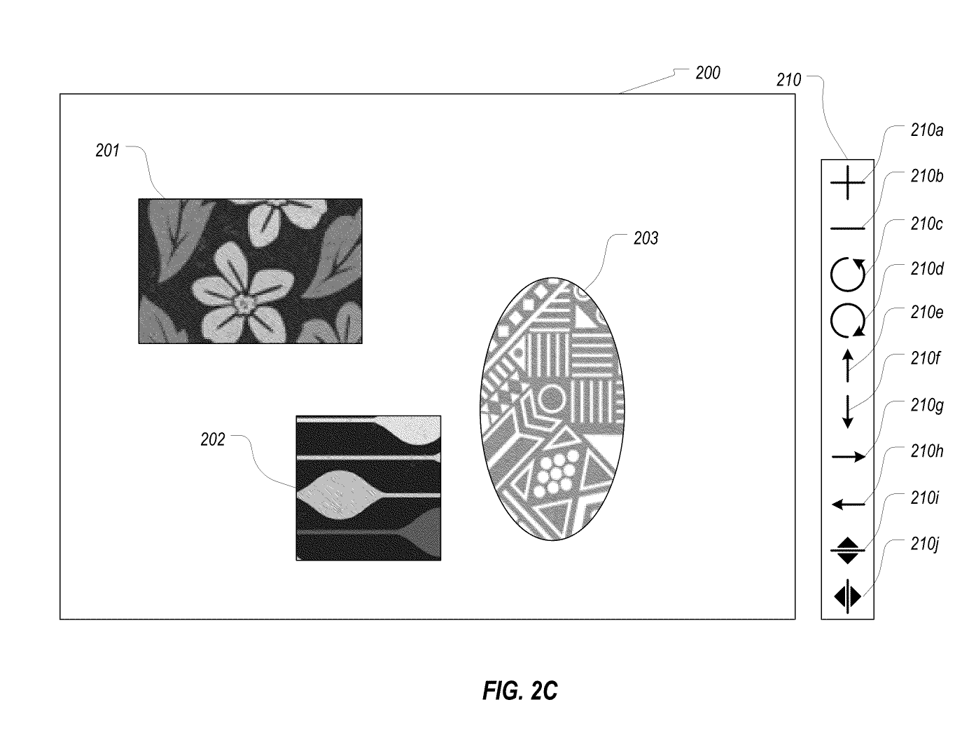

FIG. 2A illustrates an example piece of artwork 100 that can be provided by server system 101 for display within a browser on any of consumer computing devices 102a-102n. Artwork 200 can be generated from SVG or another vector image format. Although the remainder of the specification will refer to SVG, it is to be understood that the present invention can equally be implemented using other vector image formats.

As shown, artwork 200 includes three shapes including a rectangle 201, a square 202, and an oval 203. A simplified example of the XML code defining artwork 200 can be as follows:

```
<svg>
    <rect x=“1” ”y=“1” fill=“none” stroke=“black” width=“1400”
    height=“1000”/>
    <rect x=“150” y=“200” fill=“none” stroke=“black” width=“425”
    height=“275”/>
    <rect x=“450” y=“625” fill=“none” stroke=“black” width=“275”
    height=“275”/>
    <ellipse fill=“none” stroke=“black” cx=“925” cy=“600” rx=“150”
    ry=“250”/>
</svg>
```

The first <rect> defines the outer box of the artwork which has a width of 1400 and a height of 1000. This <rect> can therefore represent a 14×10 image. The second <rect> defines rectangle 201, the third <rect> defines square 202, and the <ellipse> defines ellipse 203. Artwork 200 is a simple example that employs basic shapes rather than paths. When custom shapes are included, a <path> tag would be included in the XML code with the instructions defining the lines of the custom shape. A path may define any shape or number of shapes (e.g., a number of circles). Therefore, a custom shape is not limited to a single enclosed area, but can include any number of enclosed areas.

Each of the shapes in this example have no fill (fill=“none”) and a black outline (stroke=“black”). However, when artwork 200 is initially displayed, each of the shapes may include a pattern (e.g. fill=“some_pattern”). An artist can create artwork, such as artwork 200, and provide this artwork to server system 101. As stated above, the artwork can be defined using SVG. Because the artwork is defined using SVG, some or all of the shapes in the artwork can be given a fill or pattern in the form of a raster-based image.

In accordance with embodiments of the invention, server system 101 (whether directly via a browser based approach or indirectly via a dedicated application executing on a consumer computing device) can provide an editor for manipulating a pattern that is used to fill an SVG-defined shape in a piece of artwork. This editor can provide the ability to select which pattern is applied to a particular shape or group of shapes and to manipulate the pattern once applied to the shape or group of shapes.

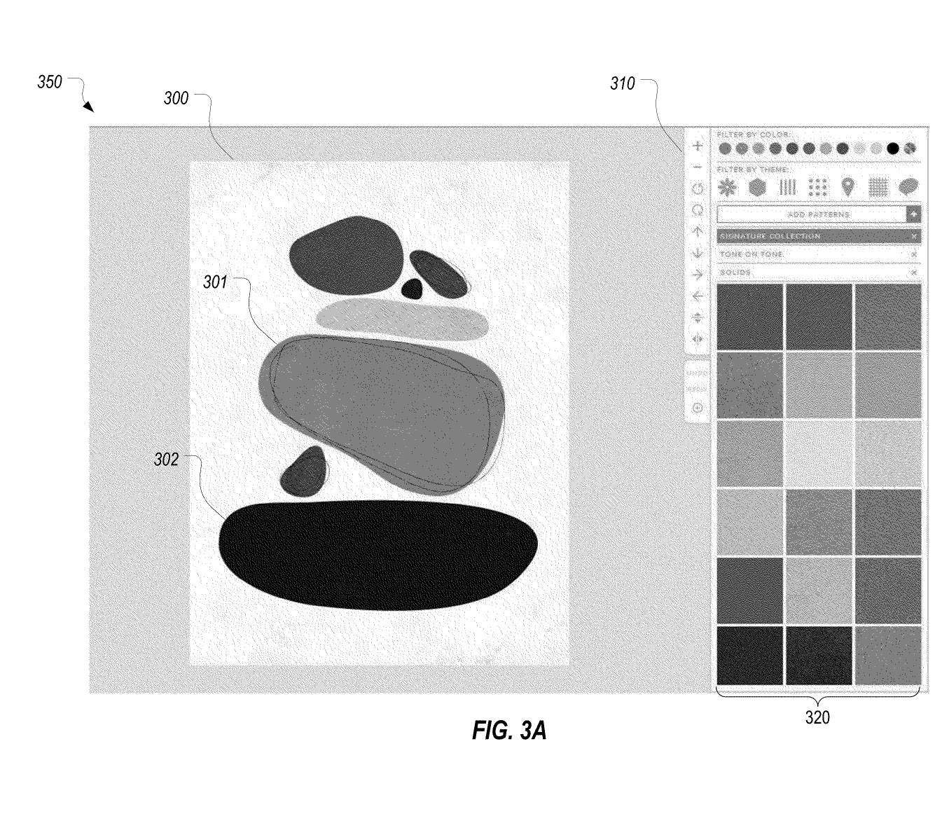

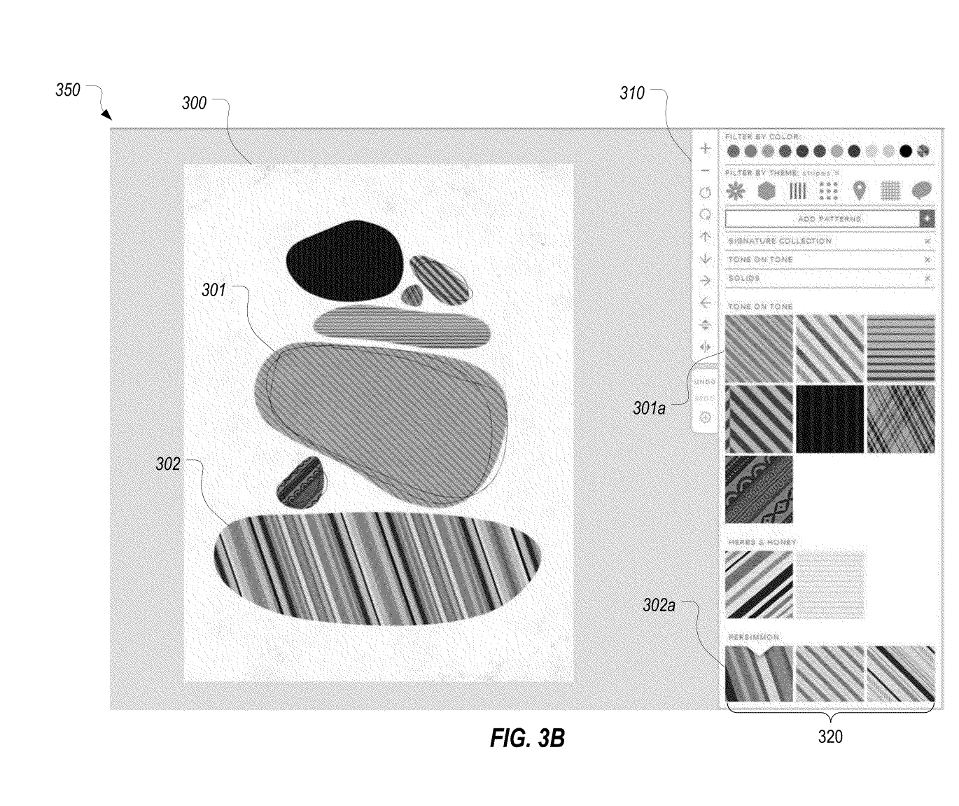

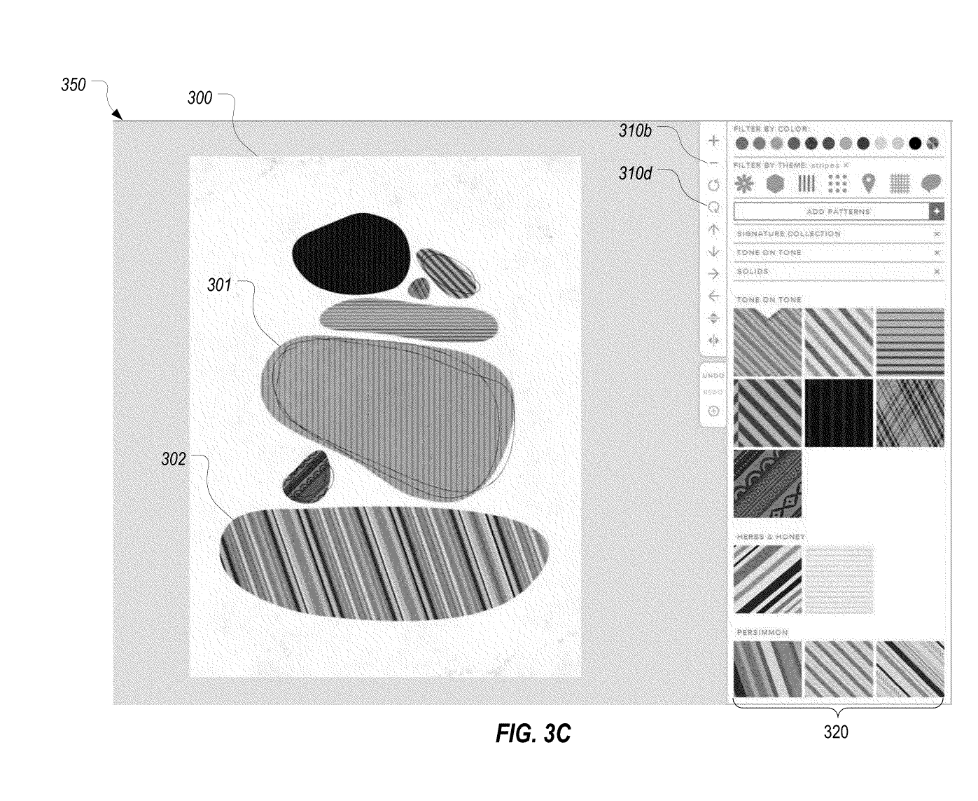

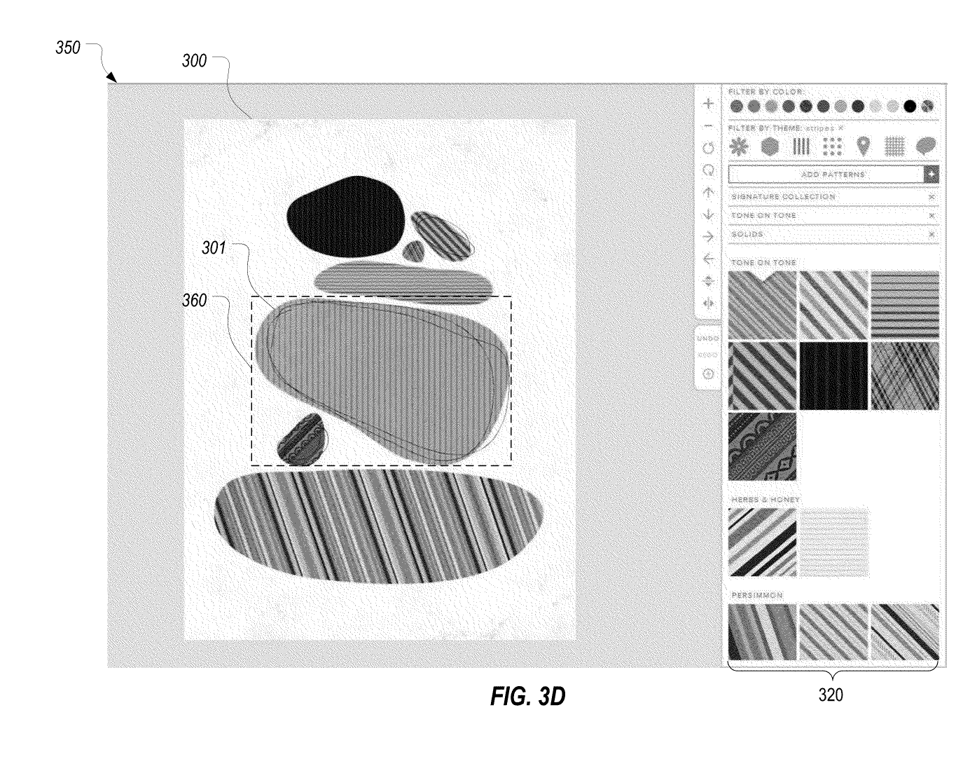

FIGS. 2B and 2C each illustrate a simplified example of an editor toolbar 210 that can be provided to facilitate manipulations of the patterns assigned to shapes 201-203. Editor toolbar 210 can be displayed within a browser alongside a displayed artwork. Although not shown in FIG. 2C, an editor may also display a number of patterns that could be selected to apply the pattern to a shape. The selection of patterns will be described below with reference to FIGS. 3A-3D.

As shown in FIG. 2B, each of shapes 201-203 has been assigned a different pattern. These patterns may have been defined by the artist or may have been selected by the consumer. In either case, editor toolbar 210 provides various manipulation options 210a-210j for manipulating how each of the patterns is displayed within the shape.

Options 210a and 210b allow the consumer to increase and decrease the scale of the pattern. Options 210c and 210d allow the consumer to rotate the pattern. Options 210e-210h allow the consumer to translate the pattern up, down, right, and left. Finally, options 210i and 210j allow the consumer to invert the pattern vertically and horizontally.

The editor can allow the consumer to select a particular shape's assigned pattern (e.g. by clicking on the pattern within the shape) and then select a particular option. In response, the editor will modify the pattern in accordance with the selected option. In some embodiments, some options can be performed by directly manipulating the pattern. For example, clicking and dragging the pattern within the shape may cause it to move within the shape.

FIG. 2C illustrates artwork 200 after various manipulations have been applied to the patterns. In FIG. 2C, the scale of the pattern applied to shape 201 has been increased (e.g. in response to the consumer selecting option 210a one or more times). The pattern applied to shape 202 has been rotated clockwise ninety degrees (e.g. in response to the consumer selecting option 210d one or more times). The pattern applied to shape 203 has been shifted to the left (e.g. in response to the consumer selecting option 210h one or more times or clicking and dragging the pattern within the shape).

Although in FIG. 2C each pattern is only customized with a single manipulation, any number of manipulations could be applied to a pattern. For example, the pattern applied to shape 201, in addition to being scaled, could be rotated clockwise and shifted up and to the left. Accordingly, the present invention enables the consumer to apply many different manipulations or degrees of manipulation to a pattern.

FIG. 3A illustrates an example of an artwork editor 350 in accordance with one or more embodiments of the invention. Editor 350 includes an editor toolbar 310 similar to toolbar 110 that provides various options for manipulating patterns. Editor 350 also includes a pattern area 320 that displays a number of different patterns from which the consumer can select. Editor 350 displays a piece of artwork 300 that includes a number of shapes including shapes 301 and 302. Each of these shapes is filled with a pattern.

A consumer can interact with editor 350 to customize the appearance of artwork 300 by changing and manipulating the patterns. FIG. 3B illustrates that the patterns of a number of shapes has been changed. For example, shape 301's pattern has been changed to pattern 301a, and shape 302's pattern has been changed to pattern 302a. In some embodiments, a pattern can be changed by selecting the pattern (or shape) within artwork 350 (e.g., by clicking on shape 301) and then selecting a pattern within pattern area 320. When a pattern is selected in this manner, the pattern will be automatically applied to the artwork such as by updating the fill attribute of the shape to point to the corresponding image file of the pattern. FIG. 3C illustrates that the patterns applied to shapes 301 and 302 have been manipulated by rotating and scaling patterns 301a and 302a via options 310d and 310b respectively.

SVG allows the fill attribute of a shape to be assigned to a pattern by reference. The pattern can then be defined elsewhere. For example, the XML code fill=“url(#pattern_id)” fills the shape with the pattern having the identifier of “pattern_id.” The following XML code represents a portion of the SVG code that defines shape 302.

```
<path
    fill=“url(#508e94)”
    d=“M1122.109,1455.088c...”>
</path>
```

In this code, the full definition of the path is omitted as evidenced by the ellipsis. The fill attribute of shape 302's path references the pattern having an identifier of 508e94. The referenced pattern is later defined using the following simplified code.

```
<pattern id=“508e94”>
    <image
        xlink:href=“http://files.modifyink.com/images/
        sample_image.tif;”
        translate(0 0)
        matrix(0.267 0 0 0.267 2639.7 2639.7)
        rotate(0 3600 3600)”>
    </image>
</pattern>
```

The definition of the pattern includes its identifier 508e94 as well as an image element which includes a reference to a .tif image that is stored at http://files.modifyink.com/images. Whatever image file is defined within the image element (i.e., whatever file xlink:href=points to) will be assigned to shape 302. Therefore, when the consumer selects a different pattern to be applied to shape 302, the XML code will be updated so that xlink:href=points to the reference (or URL) of the selected pattern.

The pattern definition shown above includes additional attributes that define the manipulations that have been performed on the pattern. The translate attribute defines how much the consumer has moved the pattern in the x and y directions. The matrix attribute is used to define the scale and whether the pattern has been inverted. The rotate attribute defines the amount of rotation to the pattern in each of three axes. Each of these attributes can be updated in response to the consumer manipulating the pattern.

The value of these attributes can be based on a bounding box that encompasses the shape to which the pattern applies. A bounding box of a shape is a rectangle that is sized so that the outer edges of the shape lie at the edges of the rectangle. FIG. 3D illustrates a bounding box 360 for shape 301. As an example, the translate attribute can identify how much the pattern has been translated from an edge of the bounding box of the shape.

The following code illustrates how the value of the matrix attribute is changed when the consumer has reduced the scale of pattern 302a as shown in FIG. 3C.

```
<pattern id=“508e94”>
    <image
        xlink:href=“http://files.modifyink.com/images/
        sample_image.tif;”
        translate(0 0)
        matrix(0.192 0 0 0.192 2909.5 2909.5)
        rotate(0 3600 3600)”>
    </image>
</pattern>
```

The matrix attribute represents an affine scaling transformation from the center of the pattern. The first four numbers represent the scaling factor in the x and y axis. In the second set of code, the change from 0.267 to 0.192 indicates a reduction in the scale. Inverting the pattern horizontally will cause the first number to become negative, while inverting the pattern vertically will cause the fourth number to become negative. The last two numbers are used to make a translation in the x and y direction respectively to make it appear that the scaling or inverting manipulation is being performed from the center of the pattern. In other words, as the pattern is scaled or inverted, the last two numbers will be updated so that the center of the pattern remains in the same location.

In a browser-based approach, the SVG code along with the code that defines the manipulation options can be contained within an HTML file. As the user interacts with the various manipulation options displayed in the webpage, the SVG code can be updated as described above so that translate, matrix, and rotate attributes identify the manipulations that the user has performed. These updates can be carried out by functions within the HTML code that are executed when the user selects one of the manipulation options or otherwise modifies a pattern. Once the consumer has finished customizing the artwork, the updated SVG code can then be used to generate a custom print.

Artwork 300 can be any of various sizes including 5″×7″, 8″×10″, 8″×12″, 11″×14″, 18″×24″, or any other size. However, the SVG code used to define the artwork displayed to the user will have a single specified size. For example, the SVG code for artwork 300 defines the size of the artwork as being 1800×2400 pixels or 18″×24″. Because each print size does not have the same aspect ratio, customizations made to artwork 300 of one size may not directly translate into a different size. Accordingly, in some embodiments of the invention, the translate and rotate manipulations made by the consumer to artwork that is displayed in a first size can be converted into relative values that can be applied to any other size of the artwork including those having different aspect ratios from the displayed size in which the manipulations were made.

To generate the relative values for the translate and rotate manipulations, the present invention can employ the bounding box of the shape to which the pattern is applied. Specifically, the present invention can calculate the percentage (or ratio) of the manipulation with respect to the longest dimension of the bounding box. In the example of FIG. 3D, the relative values can therefore be generated as the percentage of the change with respect to the horizontal length of bounding box 360. For example, assuming the horizontal length of bounding box 360 is 1300 pixels (which may be the case when an 18″×24″ version of the artwork is displayed and 100 pixels per inch is used) and that the pattern was shifted by the user by 83 pixels to the right and 6 pixels downward (which would be represented as translate (83 6) in the sample code above), the relative values generated for the translate attribute can be (6.38%, 0.46%).

After the consumer has finished customizing the artwork and the relative values have been calculated for the translate attribute, the consumer may then select the particular size that the artwork should be printed in. The SVG data for each size of the artwork, or at least the ones having different aspect ratios, will typically be defined independently (i.e., there will be different values defined for the bounding boxes in each aspect ratio including the size and position of the bounding boxes). The relative values can be used to apply the pattern to the shapes of the artwork in the selected size so that the patterns appear as close as possible to the appearance they had when the user was customizing the artwork. For example, if the consumer selects to purchase a print of the artwork that is 11″×17″ where the bounding box for shape 301 has a horizontal width of 800, the amount by which to translate the pattern in the 11″×17″ size can be (51.04 36.8) which is generated as 6.38% and 0.46% of 800 respectively. The pattern would therefore be shifted 51.04 pixels to the right and 36.8 inches down from the top left corner of the bounding box. Once the patterns have been applied to the selected size of the artwork, the artwork can be converted into a suitable printing format such as PDF format.

By employing relative values, the present invention allows a single size to be displayed to the consumer. The consumer may then make modifications to the displayed size of the artwork without being concerned for the particular size that the consumer will ultimately order. Without employing relative values, the consumer would be required to select a size prior to manipulating the patterns or be content with the inconsistencies that would result if absolute values from one size were applied to another size of the artwork.

In some embodiments, multiple shapes, whether basic or custom, can be grouped together so that a single pattern can be applied and manipulated in the same manner for each grouped shape. For example, multiple path elements may have a fill that is assigned to the same pattern identifier. Because the pattern is defined independently of the paths, when one of the shapes is selected, any manipulations made to the pattern will automatically be applied across all shapes in the group. Grouping shapes in this manner can simplify the process of customizing artwork especially when the artwork contains many shapes. Grouping shapes can also allow the artist to place limits on the amount of customization that can be made to the artwork.

The grouping of shapes can also allow the replacement of the pattern of one shape in the group to be applied to all shapes in the group. In some embodiments, shapes can be grouped using the color attribute of each shape to facilitate the replacement of the same pattern for all shapes in the group. The following simplified code illustrates how this can be accomplished.

```
<path
    fill=“url(#508e94)”
    d=“M1122.109,1455.088c...”
    color=”00AEEF”>
</path>
<path
    fill=“url(#508e94)”
    d=“M459.445,1126.251c...”
    color=”00AEEF”>
</path>
```

In the above code, two paths (or complex shapes) are defined. Each path has a color attribute assigned to the same value. Although not shown in this example, a basic shape can also have a color attribute. The present invention can use the value of a shape's color attribute to identify whether it is grouped with another shape. When the consumer selects a shape's pattern and then replaces it with another pattern, the present invention can identify any other shapes having the same color attribute and apply the same replacement.

For example, if the consumer selects the shape defined by the first path in the sample code above and then selects another pattern having an identifier of 78e21c, the first path's fill attribute can be updated to fill=“url(#78e21c)”. Further, because the first path's color attribute is assigned the value of 00AEEF, the editor can search the SVG code for any other shape having a color attribute with the same value. In this example, it will be determined that the second path in the sample code has the same value for its color attribute. The editor can then update the second path's fill attribute to fill=“url(#78e21c)”, the same value as the first path's fill attribute. In this way, when the pattern is replaced in one path, the same replacement will be made in the other path. Accordingly, grouping the shapes using the color attribute or another attribute can facilitate consistent replacement of patterns within a group of shapes while defining a pattern outside of the shape's definition facilitates applying manipulations consistently across all shapes in the group.

When shapes are grouped, the calculation of manipulation values and relative values for the manipulations is modified to account for the fact that the manipulations apply to more than one shape. In such cases, a bounding box is calculated that encompasses each of the shapes in the group. The manipulations are then calculated as described above using the bounding box that encompasses each shape. For example, the value of the translate attribute after a translation can represent an amount the pattern was translated from the group's bounding box. Similarly, the longest dimension of the bounding box that encompasses each shape can be used to generate the relative values.

In some embodiments of the present invention, each pattern can be assigned one or more constraints to ensure that the pattern, even after the consumer's manipulations, will fill the shape or group of shapes. These constraints can be based on the size of the pattern as well as the size of the bounding box that encompasses the shape or group of shapes to which the pattern is applied. For example, horizontal and vertical translation constraints can be applied to prevent the pattern from being translated to the point that the edges of the pattern will be visible within the shape. Similar constraints can apply to the other manipulations.

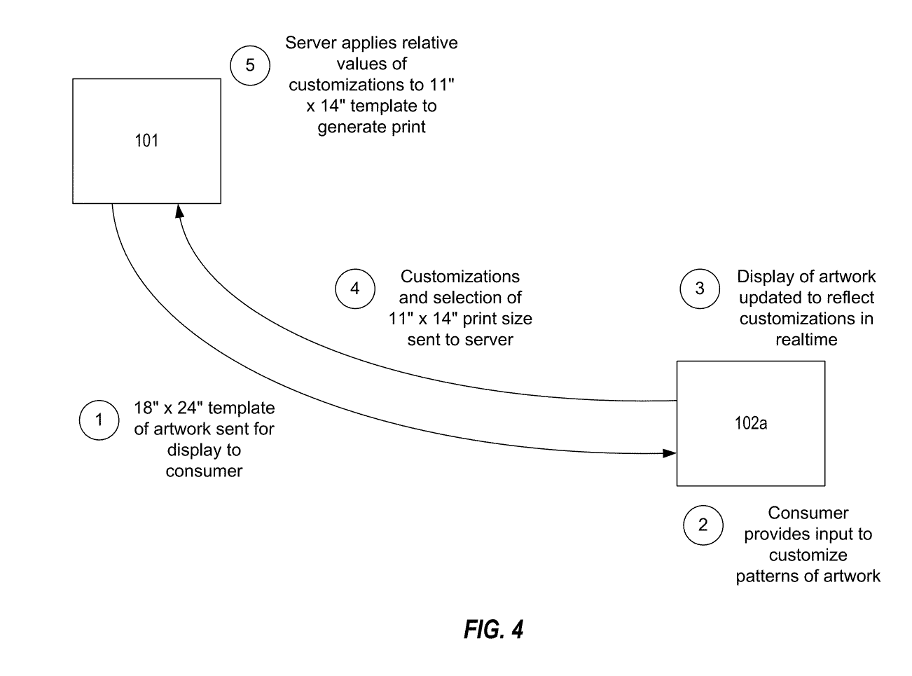

FIG. 4 provides a diagram that represents example steps that can be performed by server 101 and consumer computing device 102a to customize artwork. Although these steps are numbered and, in some instances grouped, the steps may be implemented in a different order or independent of one another. Also, some steps may be performed by both server 101 and consumer computing device 102a, or by the other device from what is shown in FIG. 4.

In step one, an 18″×24″ template of artwork is sent for display on consumer computing device 102a. Step one may be performed when the consumer accesses a website and selects the particular artwork. The 18″×24″ template is provided as a specific example, but the particular size of the template that is sent for display could be different. The consumer is not required to select a particular size of template at this step because the manipulations that will be performed will be converted into relative values as described above.

In step two, the 18″×24″ template has been displayed to the consumer, and the consumer has customized one or more patterns of the artwork. For example, the consumer may change or manipulate a pattern of one or more shapes or groups of shapes.

In step three, the display of the 18″×24″ template is updated to reflect the customizations made by the consumer. These customizations are made in realtime as the consumer makes them. The update to the display can be carried out locally by the browser or may involve communications with the server.

In step four, the customizations are sent to the server (unless they have already been sent) along with the consumer's selection of an 11″×14″ print size. Step four may be implemented once the consumer has specified that the customizations have been completed and has selected the print size. Consumer computing device 102a may be configured to generate the relative values of the manipulations and send them to server 101 or may send absolute values based on the 18″×24″ template to allow server 101 to generate the relative values.

In step five, server 101 applies the customizations (i.e., the selected patterns and the relative values of the manipulations) to a 11″×14″ template to generate a print. Server 101 can maintain a number of differently sized templates each of which can be customized using the customizations to generate a print.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for enabling a consumer to customize artwork that is defined using a vector image format, the method comprising:
displaying a first version of a first piece of artwork on a computing device, the first piece of artwork including one or more shapes that are defined using a vector image format, each shape including a pattern that is applied to the shape in accordance with the vector image format;
receiving user input that requests that a manipulation be applied to a first pattern that is applied to a first shape, the manipulation adjusting the appearance of the first pattern; and
in response to the user input, storing a manipulation value in association with the first pattern, the manipulation value defining the manipulation that was applied to adjust the appearance of the first pattern.

2. The method of claim 1, wherein the vector image format is Scalable Vector Graphics (SVG).

3. The method of claim 1, wherein the manipulation comprises one of a translation, a rotation, a scaling, or an inversion of the first pattern.

4. The method of claim 1, wherein the manipulation value is a relative value.

5. The method of claim 4, wherein the manipulation is a translation or scaling, and the relative value comprises a ratio of the translation or scaling to the longest dimension of a bounding box of the first shape.

6. The method of claim 1, further comprising:
receiving user input that requests that a print of the first piece of artwork be generated in a particular size;
accessing a second version of the first piece of artwork that is of the particular size, the second version also being defined using the vector image format;
applying the first pattern to the first shape in the second version including applying the manipulation value to the first pattern to adjust the appearance of the first pattern in the second version; and
generating the print from the second version of the first piece of artwork.

7. The method of claim 6, wherein the first version and the second version have different aspect ratios.

8. The method of claim 7, wherein applying the manipulation value to the first pattern comprises applying a relative value of the manipulation value.

9. The method of claim 8, wherein the manipulation is a translation or scaling, and the relative value comprises a ratio of the translation or scaling to the longest dimension of a bounding box of the first shape in the first version, and wherein applying the relative value to the first pattern in the second version comprises:
using the longest dimension of a bounding box of the first shape in the second version and the relative value to calculate an absolute value for the translation or scaling to be applied in the second version; and
applying the calculated absolute value to translate or scale the first pattern within the first shape in the second version.

10. The method of claim 1, wherein the first shape is grouped with one or more other shapes such that the first pattern applies to each of the grouped shapes.

11. The method of claim 1, further comprising:
receiving user input that requests that a second pattern be applied to a second shape;
determining that the second shape is grouped with one or more other shapes; and
updating the definition of the second shape and the one or more other shapes so that the second pattern is applied to the second shape and the one or more other shapes.

12. The method of claim 11, wherein determining that the second shape is grouped with one or more other shapes comprises determining that the value of a color attribute of the second shape is the same as the value of a color attribute of the one or more other shapes.

13. The method of claim 1, wherein the first shape is grouped with one or more other shapes, the method further comprising:
defining a bounding box that encompasses the first shape and the one or more other shapes; and
wherein the manipulation value is based on a dimension of the bounding box.

14. A method for enabling a consumer to customize artwork that is defined using a vector image format, the method comprising:
displaying a first version of a first piece of artwork on a computing device, the first piece of artwork including one or more shapes that are defined using a vector image format, each shape including a pattern that is applied to the shape in accordance with the vector image format;
receiving user input that requests that a first pattern be applied to a first shape;
updating the definition of the first shape such that the first pattern is applied to the first shape;
determining that the first shape is grouped with one or more other shapes; and
updating the definition of each of the one or more other shapes such that the first pattern is applied to the one or more other shapes.

15. The method of claim 14, wherein determining that the first shape is grouped with one or more other shapes comprises determining that the first shape and the one or more other shapes each have a color attribute that is assigned the same value.

16. The method of claim 14, further comprising:
receiving user input that requests that a manipulation be applied to the first pattern, the manipulation adjusting the appearance of the first pattern; and
in response to the user input, storing a manipulation value with the definition of the first pattern, the manipulation value defining the manipulation that was applied to adjust the appearance of the first pattern, the definition of the first pattern being separate from the definition of the first shape and the one or more other shapes such that by storing the manipulation value, the manipulation is applied to the first pattern of each of the first shape and the one or more other shapes.

17. One or more computer storage media storing computer executable instructions which when executed by one or more processors implement a method for enabling a consumer to customize artwork that is defined using a vector image format, the method comprising:
displaying a first piece of artwork on a computing device, the first piece of artwork being generated from a first Scalable Vector Graphics (SVG) file that defines a plurality of shapes for a first aspect ratio;
receiving user input that requests that a manipulation be applied to a first shape, the manipulation comprising one of a translation, a rotation, a scaling, or an inversion of a first pattern that is applied to the first shape;
storing a manipulation value that defines the manipulation, the manipulation value being defined with respect to the aspect ratio of the first SVG file;
selecting a second SVG file that defines the plurality of shapes for a second aspect ratio, the first pattern being applied to the first shape in the second SVG file;
modifying the manipulation value based on the second aspect ratio; and
applying the modified manipulation value to the first shape in the second SVG file such that the first pattern is manipulated in the second SVG file in accordance with the manipulation that was made to the first pattern in the first SVG file.

18. The method of claim 17, wherein modifying the manipulation value comprises calculating a relative value of the manipulation value based on a longest dimension of a bounding box that encompasses the first shape in the first SVG file, and using the relative value and a longest dimension of a bounding box that encompasses the first shape in the second SVG file to generate the modified manipulation value.

19. The method of claim 17, further comprising:
receiving user input that specifies that a second pattern be applied to the first shape; and
updating the first SVG file such that the second pattern is applied to the first shape.

20. The method of claim 19, further comprising:
determining that the first shape is grouped with one or more other shapes in the first SVG file; and
updating the first SVG file such that the second pattern is applied to the one or more other shapes.
